(19) United States
(12) Patent Application Publication
(10) Pub. No.: US 2018/0243687 A1
(43) Pub. Date: Aug. 30, 2018

(54) GAS TREATMENT SYSTEM

(71) Applicant: Edwards Limited, Burgess Hill, West Sussex (GB)

(72) Inventors: Simone Magni, Clevedon, Somerset (GB); Jerome Boegner, Clevedon, Somerset (GB); MinKyeong Noh, Cheonan-si, Chungcheongnam-do (KR); JinOk Lee, Cheonan-si, Chungcheongnam-do (KR); JiYoung Son, Cheonan-si, Chungcheongnam-do (KR)

(21) Appl. No.: 15/750,007

(22) PCT Filed: Jul. 26, 2016
(86) PCT No.: PCT/GB2016/052281

§ 371 Date: Feb. 2, 2018

(30) Foreign Application Priority Data
Aug. 4, 2015 (GB) 1513777.1

(51) Int. Cl. B01D 53/32; H05H 1/36

(52) U.S. Cl. CPC B01D 53/323; H05H 2001/3431; H05H 1/36

(57) ABSTRACT

A method of controlling power output by a power supply configured to supply power to a plasma torch in a gas treatment system, the plasma torch being configured to treat effluent gas received from at least two processing chambers is disclosed, along with a controller and the gas treatment system. The method comprises: receiving at least one input signal, the at least one input signal comprising an indication of a number of processing chambers currently supplying an effluent gas stream to the plasma torch; and in response to the at least one input signal, controlling the power output by the power supply by outputting a control signal to control a rate of flow of the plasma source gas.

### CROSS-REFERENCE TO RELATED APPLICATION

This application is a Section 371 National Stage Application of International Application No. PCT/GB2016/052281, filed Jul. 26, 2016, which is incorporated by reference in its entirety and published as WO 2017/021693 A1 on Feb. 9, 2017 and which claims priority of British Application No. 1513777.1, filed Aug. 4, 2015.

### FIELD

The field of the embodiments relate to the control of the power output by a power supply configured to supply electrical energy to a plasma torch for treating a gas stream from multiple process chambers. The embodiments also relate to an apparatus for treating the gas stream and to a flow regulating device for regulating the flow of the gas stream.

### BACKGROUND

Plasmas can be generated to treat an effluent gas stream from a manufacturing process used in, for example, the semiconductor or flat panel display manufacturing industry. During such manufacturing, residual fluorinated or perfluorinated compounds (PFCs) and other compounds exist in the effluent gas stream pumped from the process tool. These compounds are difficult to remove from the effluent gas stream and their release into the environment is undesirable because they are known to have relatively high greenhouse activity and in some cases can be toxic.

Plasmas for abatement devices can be formed in a variety of ways. Microwave plasma abatement devices can be connected to the exhaust of several process chambers. Each device requires its own microwave generator, which can add considerable cost to a system. Plasma torch abatement devices are advantageous over microwave plasma abatement devices in terms of scalability and in dealing with powder (present in the effluent stream or generated by the abatement reactions).

Plasma torches require a high electrical field to be applied between an anode and cathode between which a source gas flows in order to initiate a breakdown discharge. If enough current between the anode and cathode is provided, the ionisation of the source gas is sustained and a plasma plume (or flare) is formed at the anode exit. The effluent gas stream is mixed with the plasma plume and the undesirable compounds are broken down. Plasma torches can consume considerable power and the high electrical field or high electrical current can damage both the cathode and the anode. Control of the power supplied to the plasma torch is not straightforward as increases in the current through the plasma causing the voltage to fall.

WO2013/024248 discloses a plasma torch for use in an abatement device for treating the output of a chemical vapour deposition process. It recognises that the control of power supplied to such a plasma torch has conventionally been difficult to manage and as such plasma torches have generally operated at a constant power. It also recognises that in some situations where a process outputs different gases at different times, then these gases may require different amounts of electrical power to be supplied to the torch for effective treatment. This is due to the fact that some compounds are more stable than others requiring a higher power to break them down. It addresses this problem by varying the amount of source gas and electrical current supplied to the plasma flare which in turn varies the power of operation of the plasma torch allowing the torch to be used for the treatment of different gases.

JP2006202605 discloses a method of controlling a current supplied to a plasma torch during a start up phase of the torch and then during operation in dependence upon a temperature of components in the vicinity of the plasma plume.

The supply of power to plasma torches can be problematic due to their high power consumption, and due to variations in power consumption due to anode erosion and powder deposition. Accordingly, it is desired to provide an improved technique for controlling the power supplied to a plasma torch and for processing an effluent gas stream.

The discussion above is merely provided for general background information and is not intended to be used as an aid in determining the scope of the claimed subject matter. The claimed subject matter is not limited to implementations that solve any or all disadvantages noted in the background.

SUMMARY

According to a first aspect, there is provided a method of controlling power output by a power supply configured to supply power to a plasma torch in a gas treatment system, said plasma torch being configured to treat effluent gas received from at least two processing chambers, said method comprising: receiving at least one input signal, said at least one input signal comprising an indication of a number of processing chambers currently supplying an effluent gas stream to said plasma torch; and in response to said at least one input signal, controlling said power output by said power supply by outputting a control signal to control a rate of flow of a plasma source gas supplied to said plasma torch.

The embodiments recognize that there may be occasions where it may be desirable to vary the power supplied by a power source to a plasma torch. In this regard, a plasma torch must operate between certain power limits; a power input that is too low will cause quenching of the plume while a power input that is too high may cause damage to the electrodes of the plasma torch and may be beyond the capabilities of the power supply. For this reason, many plasma torches are operated at a constant power which is sufficient to generate a plume and not to damage the torch.

A particular problem arises where there are multiple processing chambers treated by a single plasma torch. Such an arrangement has the advantage of reduced hardware and servicing requirements over systems with one torch per chamber, however, the power requirements of such a torch are high and thus, operating it at a constant power sufficient to treat all processing chambers is expensive on power. It would be desirable to be able to determine when a lower power may be acceptable and when such a situation is detected to be able to control the power output by the power supply automatically.

For example, with multiple processing chambers supplying effluent gas to a plasma torch, there may be some occasions where they are not all currently active, perhaps just a subset which may be one or more of them are currently active, and as such the amount of effluent that the plasma torch is treating may vary considerably. Receiving input signals indicating the number of processing chambers currently supplying an effluent gas stream to the plasma torch could be used to determine when it may be possible to reduce power supplied to the torch. The power output to the power supply may be varied in a number of ways such as by varying a level of current and/or voltage output by the power supply, however, it may be advantageous to control the power by controlling the rate of flow of the plasma source gas as this controls the resistance between the electrodes and is an effective way of controlling the power output.

Thus, where the plasma torch is treating more than one processing chamber, then it is advantageous if a signal indicating the number of processing chambers that are currently supplying effluent gas to the plasma torch is provided as this can be used in the control of the power output by the plasma torch. A plasma torch that treats the effluent from many chambers will necessarily consume a relatively large amount of power and being able to reduce that on occasion can be very advantageous.

In some embodiments, said at least one input signal comprising said indication of said number of processing chambers comprises a signal received from each of said processing chambers.

The indication of the number of processing chambers that are currently supplying effluent can be determined in a number of ways and may be determined from a signal received from each of the processing chambers. The signal may be: a signal indicating whether a pump supplying effluent from the corresponding process chamber is currently operational; and/or a signal indicating whether a bypass valve associated with the processing chamber is currently in a position to supply effluent gas from the chamber to the plasma torch or in a position to bypass the plasma torch and vent the gas; and/or an indication of a current process occurring in a processing chamber which may indicate whether a processing chamber is currently generating an effluent or not.

In some embodiments, each of said processing chambers comprises a bypass valve, said bypass valve being configured to supply said effluent from said corresponding processing chamber to said plasma torch in a first state and not to supply said effluent to said plasma torch in a second state, said method comprises a further step of outputting at least one control signal to control at least one of said bypass valves.

In addition to controlling the power output by the power supply, in some embodiments the method may further control the state of bypass valves associated with each processing chamber, such that on detecting that one of the multiple processing chambers is not currently generating any effluent gases then any gases output by the chamber can be vented. This not only allows the power output by the plasma torch to be reduced, but it also reduces dilution of the effluent that is output by other processing chambers, which is advantageous as dilution reduces the efficacity of the gas treatment.

In some embodiments, in response to determining at least one of said multiple pumps switching between operational and non-operational states, controlling said corresponding at least one bypass valve to switch between said first and said second states such that when said pump is not operational said corresponding bypass valve does not supply effluent to said plasma torch.

Furthermore, where one of the pumps supplying the effluent from the process chamber to the plasma torch has become non-operational due to the processing chamber being in an idle state then the bypass valve switching to a vent position avoids or at least reduces pressure rises occurring within the chamber which could result in backflow of gases from the processing chamber towards the processing chamber input.

In other embodiments, the signal to control the bypass valve is output in response to determining at least one of said processing chamber switching between an idle and an operational state.

In some embodiments, the method comprises a further step of outputting a further control signal for controlling a rate of flow of reagent for treating said effluent gas stream in dependence upon said number of processing chambers currently supplying effluent to said plasma torch.

In some cases, reagents may be used to treat the effluent gas stream in addition to the plasma. For example, chemicals such as oxygen and water vapour may be added to oxidise the chemicals and it is advantageous if the amount added can be varied as a function of the number of process chambers currently supplying effluent in order to match the required stoichiometry. This can reduce NOₓ emissions and the cost of operation and has a beneficial impact on both the amount of harmful chemicals emitted and the lifetime of the components of the plasma torch and the sections downstream of the torch.

In some embodiments, said plasma torch comprises at least two anodes, said plasma source gas being supplied to said plasma torch in at least two plasma source gas streams at at least two points in said plasma torch, said step of controlling said rate of flow of said plasma source gas stream comprises independently controlling a rate of flow of each of said at least two plasma source gas streams.

The plasma torch may comprise more than one anode with source gas flows being introduced to the plasma torch above each of the anodes. Changes in each gas flow has a different effect, the gas flow where ionisation occurs affecting the power supplied and the gas flow around the plume helping to stabilise the plasma torch plume protecting the components. As the two gas flows affect operation differently, independent control of the two gas flows in dependence upon input signals may be advantageous. In this regard the source gas flow that is ionised and supplies the plume is the one that is controlled to control the power consumed by the torch.

In some embodiments, it may be desirable for further input signals to be received and monitored including at least one of the current output to the plasma torch, the voltage output to the plasma torch and the flow rate of the plasma source gas supplied to the plasma torch. Each of these quantities provide an indication of the current power output by the power device and may be changed in certain circumstances and thus, it may be desirable to monitor them.

In some embodiments said power supply is configured to supply a substantially constant predetermined DC current to said plasma torch.

It may be advantageous to have a plasma torch that is supplied with a DC substantially constant current. A DC power supply has the advantage of not having the same load matching requirements as an AC power supply making it simpler and often cheaper to implement. Where a DC power supply is used then a constant current may be supplied to the electrodes to maintain the plasma plume. In such a case varying the rate of flow of source gas supplied to the plasma torch will vary the resistance and where current is maintained constant the power supplied will also vary in a predictable manner Further control of the power supplied can be attained where required by controlling the predetermined value of the constant current that is supplied to the plasma torch. Such control may be required where the properties of the plasma torch have changed over time, such that keeping the power within required limits is not possible by simply varying the source gas flow and a different current is required.

In some embodiments, said at least one input signal comprises a signal indicative of said power output by said power supply, said method comprising a further step of monitoring changes in said power output and where said changes take a power output by said power supply outside of predetermined limits, outputting a control signal to adjust said power output by said power supply to be within said predetermined limits.

The required power of the plasma torch is also affected, by changes over time at the anode of the plasma torch that may be damaged, corroded and/or suffering from powder deposition. This leads to changes in the voltage level required to generate a particular current in a constant current power supply, or for a constant voltage power supply changes in the current generated by the constant voltage. Monitoring changes in the power level, allows the power control system to become aware of where the power consumed by the power supply is passing outside of predetermined limits and in such a case, the power output may be adjusted in some cases by adjusting the rate of flow of the plasma source gas to move the power consumed back to within desired levels.

In some embodiments, prior to outputting the control signal to adjust the power output by the power supply, the method comprises the further step of determining whether adjusting said power by adjusting the flow rate of the plasma source gas will bring the flow rate outside of predetermined flow rate limits and if so outputting a control signal to adjust a level of said current or voltage output by said power supply to bring said power output within said predetermined power limits.

The power supplied by the plasma torch can only be varied a certain amount by adjusting the rate of flow of the plasma source gas as there are limits beyond which this flow rate should not be varied as this may lead to operational problems such as the plasma flare being quenched. Thus, at a certain point, in order to keep the power within predetermined limits, it may be desirable and/or required to alter the power output by the power supply by varying the current and/or voltage output to maintain the power within the predetermined power limits. Where the power supply is a constant current power supply then the constant current is varied to a different substantially constant value, while where it is a constant voltage power supply it is the constant value of the voltage that is changed.

In some embodiments, the method comprises a further step of outputting an anode inspection signal in response to determining that one of said current or said voltage output by said power supply has reached at least one predetermined value.

Where changes in power level have been compensated for by changing the constant current level or constant voltage level of the power supply as changes in the flow of source gas were no longer sufficient, then this is an indication that anode erosion or powder deposition on the anode is causing significant changes in the plasma torch's functioning and it may be good practice to inspect the anode as it may require cleaning or replacing. In this regard, it is desirable for an operator of the plasma torch to be aware of its power consumption and for this power consumption not to vary unduly over time.

A second aspect of the embodiments provides a computer program which when executed by a processor is operable to control said processor to perform steps in a method according to a first aspect of the embodiment.

A third aspect of the embodiments provides a controller for controlling a power output by a power supply configured to supply power to a plasma torch in an abatement system, said controller comprising: an input configured to receive at least one input signal, said at least one input signal comprising an indication of a number of processing chambers currently supplying effluent to said plasma torch; logic configured to generate at least one control signal in dependence upon said at least one input signal, said at least one control signal controlling said power output by said power supply by controlling a rate of flow of a plasma source gas supplied to said plasma torch; and an output for outputting said generated control signal.

In some embodiments, the power supply is configured to supply a predetermined substantially constant DC current.

Although the power supply can be an AC or a DC power supply, it may be advantageous if a DC power supply is used. DC power supplies are generally simpler and cheaper and matching the load to avoid reflection of the power signal is not required.

In some embodiments, the logic within the controller comprises programmable control logic comprising a computer program according to a second aspect of embodiments. Alternatively the logic within the controller may be implemented in hardware.

A fourth aspect of the embodiment provides an apparatus for treating a gas stream from multiple processing chambers comprising: a plasma torch for generating a plasma plume from a source gas when energised by electrical energy; a power supply for supplying said electrical energy to said plasma torch; a flow rate regulator for regulating a rate of flow of said plasma source gas to said plasma torch; and a controller according to a third aspect of embodiments for controlling said power output by said power supply.

In some embodiments, said flow rate regulator comprises: an input channel and an output channel, said input channel being in fluid communication with an input manifold and said output channel being in fluid communication with an output manifold; a plurality of flow channels running from said input manifold to said output manifold; a movable obstructing member operable to move within one of said input or output manifold to obstruct one or more of said plurality of flow channels in response to a control signal received from said controller, movement of said obstructing member being operable to vary a number of channels available for flow of said plasma source gas from said input channel to said output channel, and thereby vary said flow rate of said source gas supplied to said plasma torch.

A simple, effective, low cost and yet accurate way of controlling the flow rate of the plasma gas is to use a device with plural flow channels between an input manifold and an output manifold such that obstruction or opening of these channels will affect the effective cross-sectional area available for fluid flow and therefore the fluid flow rate. Furthermore the control of flow rate in this manner is inherently repeatable improving accuracy over time.

Although the channels between the manifolds can have a number of forms, in some embodiments they are parallel channels and in some cases they may have the same cross-sectional area, while in others they may have different cross-sectional areas. In this regard, the cross-sectional area of a channel will affect the amount of gas that flows through it and thus, having channels with different cross-sections allows the flow rate to be varied with differing levels of accuracy depending which of the channels are obstructed. However, having them of the same cross-sectional area provides a simple and effective way of controlling fluid flow in a proportional manner This can be advantageous where changes in power required may vary proportionally due to one or more processing chambers going on or off line

In some embodiments, said flow rate regulator comprises a stepper motor to control said movement of said obstructing member and thereby said number of channels obstructed.

An obstructing member that moves in a linear manner to obstruct the channels can be controlled by a stepper motor allowing for a simple control of the flow regulating in response to control signals.

In some embodiments, a reagent may be input to the plasma torch and a flowrate regulator may also be used to regulate the amount of reagent input to the plasma torch in dependence upon the number of processing chambers that are currently supplying effluent to the plasma torch. In this regard, it may be advantageous if the number of channels is equal to the number or a multiple of the number of chambers and thus as each new chamber comes online, a new or multiple new channels are opened and when a chamber goes offline, a corresponding channel or multiple channels are closed. In this way, the amount of reagent supplied to the torch can be varied in a way that is proportional to the number of chambers that is operational. A similar system may be used with the plasma gas source flow.

In some embodiments, said plasma torch comprises a plurality of inputs for receiving effluent gas streams from a corresponding plurality of processing chambers.

In some embodiments, said plasma torch comprises four inputs for receiving effluent gas streams from four processing chambers.

In some embodiments, said plasma torch comprises a cylindrical anode, and a cathode located at least partially within said cylindrical anode, said power supply supplying an electrical signal to said cylindrical anode.

In some embodiments, said plasma torch comprises a plurality of anodes with a plurality of plasma source gas inputs, plasma source gas supplied to each plasma source gas input being controlled by a flow rate regulator.

A fifth aspect of the embodiment provides a flow rate regulator for regulating a flow of a fluid comprising: an input channel and an output channel, said input channel being in fluid communication with an input manifold and said output channel being in fluid communication with an output manifold; a plurality of flow channels running from said input manifold to said output manifold; a movable obstructing member operable to move within one of said input or output manifold to obstruct one or more of said plurality of flow channels in response to a control signal, movement of said obstructing member being operable to vary a number of channels available for flow of said fluid from said input channel to said output channel, and thereby vary said flow rate of said fluid supplied from said flow rate regulator.

In some embodiments, said plurality of channels of said flow rate regulator are substantially parallel channels.

In some embodiments, said plurality of channels have substantially a same cross sectional area, while in others they have different cross sectional areas.

In some embodiments, said obstructing member is operable to move in a linear manner in one of said input or output manifold.

In some embodiments the flow rate regulator, further comprises a stepper motor operable to control said movement of said obstructing member and thereby said number of channels obstructed.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

The embodiments will now be described further, with reference to the accompanying drawings, in which:

FIG. 1 shows a plasma torch for use in the treatment of gas according to an embodiment;

FIG. 2 schematically shows an abatement system comprising the plasma torch of FIG. 1 and a controller according to an embodiment;

FIG. 3A and 3B show how voltage and current of the power supply unit supplying power to the plasma torch change with source gas flow rate;

FIG. 4 schematically shows the input and output signals of a control system according to an embodiment;

FIG. 5 shows a dual anode plasma torch with two source gas inputs according to an embodiment;

FIG. 6 shows multiple inputs to a plasma from multiple process chambers according to an embodiment;

FIG. 7 shows power modulation for a four chamber etch and how changes in the flow rate affect the power input to the power supply unit of the plasma torch;

FIG. 8 is a flow diagram showing steps in a method for automatic control of the power supplied to a plasma torch as a function of the process online signal input;

FIG. 9 shows a proportional flow tube flow regulator for regulating a source gas or reagent according to an embodiment; and

FIG. 10 shows a flow diagram illustrating steps performed to achieve a fixed regulated power in the presence of voltage variation due to anode erosion.

### DETAILED DESCRIPTION

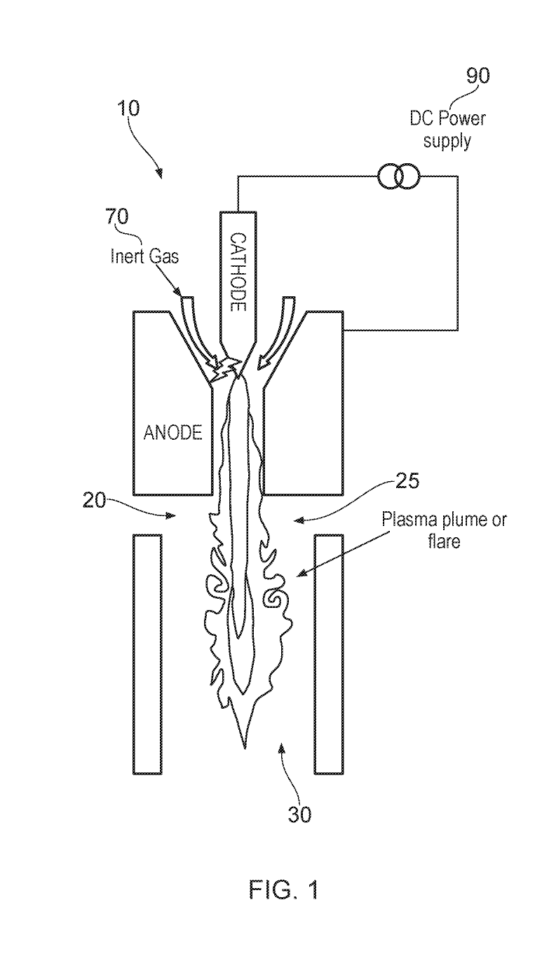

FIG. 1 shows a plasma torch 10 for use in the treatment of gas according to an embodiment. Plasma torch 10 has a cathode and an anode to which a DC power supply 90 supplies a substantially constant current. An inert source gas 70, flows between the cathode and the anode and the electric field between these electrodes causes an electrical discharge through the inert gas ionising the gas and forming a plasma plume. The core temperature of the plasma plume may be between 4,000-6,000° C. A reagent 20 is input to the plasma plume as is a process gas 25 output from a processing chamber in, for example, a semi-conductor etching process. The gases and plasma pass through a mixing region 30 where the reagent 20, the process gas 25 and the plasma plume mix. The high temperature of the plasma plume and the presence of the reagent cause chemicals within the process gas to react or be broken down to form other less harmful or polluting chemicals. In this way, an effluent process gas output from a process chamber can be treated to remove greenhouse and toxic gases.

In order for the process gas to be effectively treated and to reduce damage to the anode, the amount of reagent should be controlled to correspond to the amount required to react with the amount of process gas to be treated. Similarly the inert gas flow should be controlled to control both the power supplied by the constant current DC power supply and to reduce excess dilution of the process gas.

The process gas 25 that is received at the plasma torch 10 may be received from multiple process chambers. In this regard, effluent or process gases output from a process chamber will need to be treated and providing each process chamber with its own plasma torch has significant hardware, servicing and control overheads. Providing a single torch with sufficient power to treat the effluent from multiple chambers can be an effective way of reducing these overheads. However, unless power output by the power supply unit can be effectively controlled such a solution may have significant power consumption overheads.

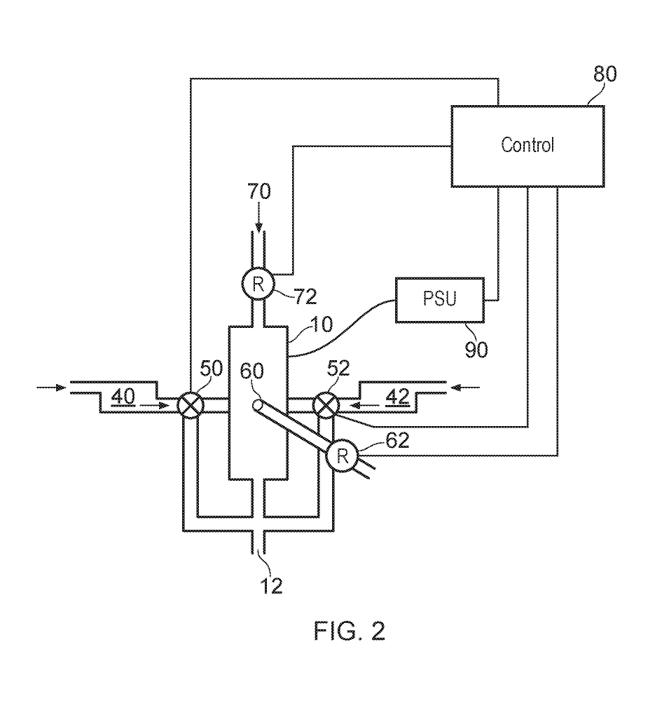

FIG. 2 shows an embodiment where multiple chambers 40, 42 each supply effluent gases via bypass valves 50 and 52 to plasma torch 10. A reagent is input through input 60 and the amount of reagent supplied is controlled by flow regulator 62.

Where there are multiple chambers supplying the plasma torch 10, then the variation in amount of effluent that is being supplied to the plasma torch at any one time may be considerable, particularly where the process cycles of the individual chambers are not synchronised such that at any one time one or more may be in an idle state and not currently supplying effluent. Careful control of the power supplied to the plasma torch may therefore be required to retain its high performance and to reduce unnecessary power consumption.

In this embodiment, the amount of source gas 70 supplied to plasma torch 10 is controlled by a flow regulator 72. Control logic 80 controls the flow regulator 72 to supply a predetermined flow rate. This predetermined flow rate is changed with the number of processing chambers that are operational. In this embodiment power supply unit 90 is configured to supply a substantially constant DC current to plasma torch 10. Control of the flow rate of source gas controls the resistance between the electrodes and the amount of power consumed. Thus, by controlling the flow rate of the source gas 70 the controller 80 controls the power consumed by the plasma torch. Similarly for a constant voltage power supply control of the flow rate will change the resistance and thus, the current generated by the constant voltage and in this way control of the source gas flow rate will control the power output by the power supply unit

Control logic 80 receives signals from the processing chambers 40 and 42 and from these determines whether they are currently operational and/or what part of the process cycle they are currently in. It uses these signals to determine the required power and to control the flow of source gas via the flow rate regulator. Control logic 80 is also configured to control bypass valves 50 and 52 in dependence upon the operational status of the processing chambers, such that where they are not generating effluent gases that need treating any other gases that may be output can be vented. This avoids these gases diluting effluent gases which do need treatment.

As noted, the control logic 80 is able to determine which process chambers are currently idle and which are not from signals received from the process chambers and in response to this, the controller sends control signals to the bypass valves 50 and 52 such that when a process chamber is not currently operational the bypass valve is set to create a flow path between the process chamber and the exhaust 12 of the plasma torch such that any gas from a non-operational process chamber is vented and does not pass to the plasma torch. This is acceptable as there is no process currently occurring and thus, no gases that need treating. One feature of plasma torches is that their effectiveness changes with dilution of the gases to be treated and thus, injecting gases into the plasma plume which do not require treatment causes dilution of those that are to be treated and the efficiency of the torch falls. Thus, providing bypass valves which allow gases from process chambers to bypass the torch when the process chambers are not operational can significantly increase the efficiency of a multiple chamber abatement system. Furthermore, the bypass valves can relieve any pressure build up in a process chamber and reduce the likelihood of backflow of gasses from the process chamber towards the gas input. Providing automatic control of these bypass valves based on signals received from the processing chamber provides an effective and efficient system.

In this embodiment the flow of source gas 70 is controlled by flow regulator 72 in dependence upon how many of the process chambers 40, 42 are currently active. In this regard, although only two process chambers have been shown for ease of representation, it should be understood that there may be considerably more each supplying effluent to a single plasma torch. Thus, control logic 80 will determine from signals received from the individual process chambers and/or from signals from bypass valves 50, 52 which of the chambers are supplying effluent gas to the plasma torch and will adjust the flow of source gas accordingly. In this regard, the process chambers may send indications of their current point in the processing cycle or they may send indications from the pump that pumps gas into the chamber or signals may be received from the bypass valves indicating their status. In this regard, the bypass valves may be controlled by control logic associated with the process chamber in which case their status which is an indication of whether or not effluent gases are being sent to the plasma torch can be used as an input to the controller. Alternatively, in some embodiments the bypass valves are themselves controlled by the controller controlling the power supply which is receiving other signals indicative of the processing status of a processing chamber from the chambers. In any case signals received that are indicative of which chamber is currently supplying effluent gas to the plasma torch can be used by the controller to determine the required flowrate of the source gas flowing into the plasma torch and in this way the power supplied to the torch. This ability to control the power reduces the power consumption and improves the efficiency of the system.

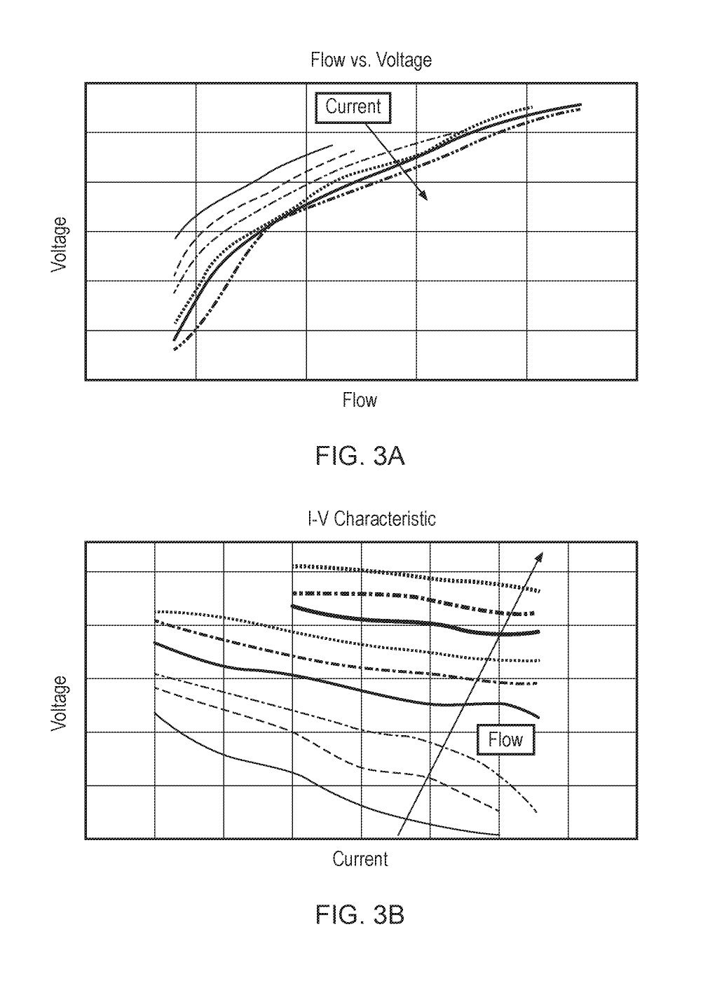

FIG. 3A schematically shows how voltage changes with the flow of source gas with different output currents. Thus, as the flow of source gas increases, the voltage required to maintain a current will also increase initially, plateauing out at a certain point. FIG. 3B shows a similar graph of how voltage changes with current for different rates of flow of source gas. As can be seen, as the source gas flow rate increases a higher voltage is required to generate the same current, while for the same flow of source gas as current increases the voltage drops. This aspect of the voltage dropping with increasing current makes the power supply to the plasma torch difficult to control by voltage and current alone which is why controlling changes in source gas flow can be an effective means of control.

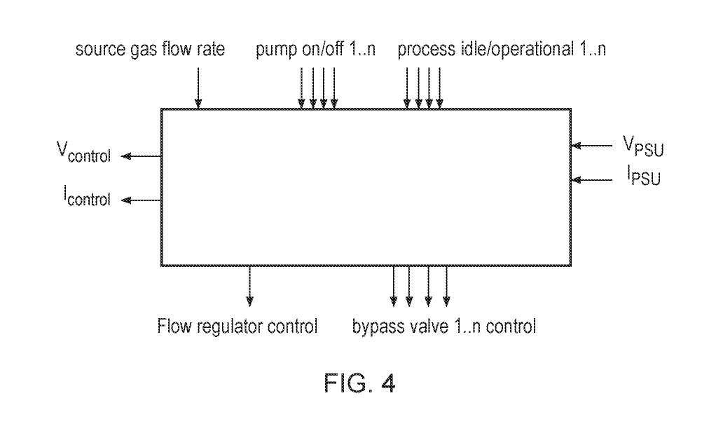

FIG. 4 schematically shows controller 80 of FIG. 2 in more detail. Controller 80 receives a number of input signals and outputs a number of control signals. In this embodiment, it receives input signals indicating the rate of flow of the inert source gas transmitted to the plasma torch and it also receives input signals from the multiple process chambers supplying effluent gas to the plasma torch. The input signals indicate whether the process chamber pump is on and/or whether the process is currently idle. The controller also receives a voltage and current signal from the power supply unit indicating the current voltage and current being output by this unit. It will process these input signals and from these will generate output control signals to control the bypass valves such that effluent from the different process chambers are not transmitted to the plasma torch when the corresponding process chambers are idle and/or when their pumps are not operational. It will also control the rate of flow of source gas supplied to the plasma torch in dependence upon the number of chambers currently operational. In some embodiments it may also control the flow rate of reagent gases supplied to the plasma torch in dependence upon the number of chambers currently operational.

In some embodiments the controller will also control the voltage and/or current supplied by the power supply unit. In some cases where the control in the flow of source gas is not sufficient to control the power to within required limits, the controller will control the power output by the power supply unit by changing at least one of the voltage or current output. In this regard in the case of a constant current power supply as shown in this embodiment it will be the current that is varied to maintain the power within the required limits.

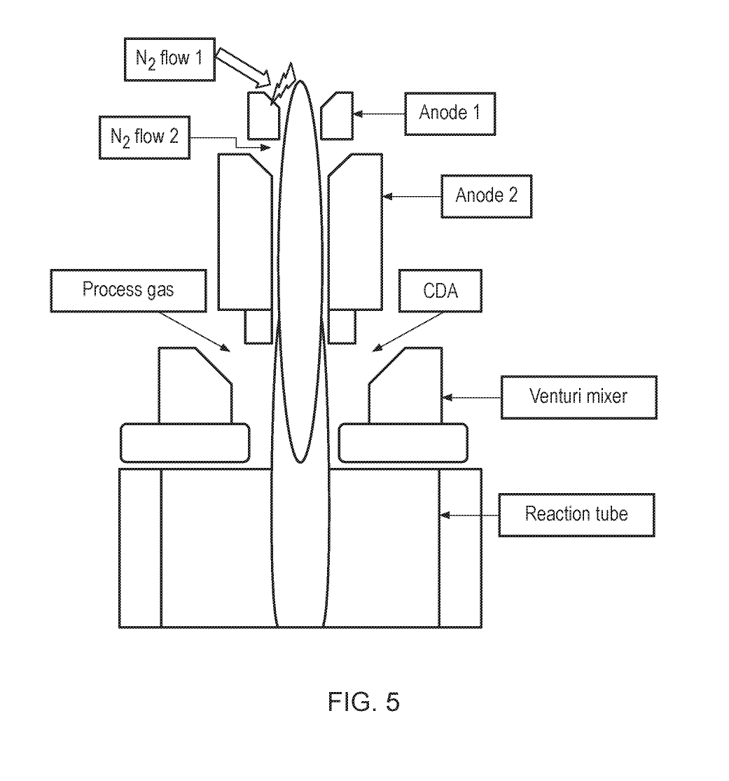

FIG. 5 shows an alternative embodiment of a plasma torch where there are two anodes and two source or inert gas flows, flow 1 and flow 2, which in this case is Nitrogen. Providing a two stage anode can produce a longer plasma reaction area resulting in higher destruction efficiency and can produce better mixing. Control of the two Nitrogen flows can improve performance and thus in some embodiments, controller 80 will provide independent control to each of the two source gas inlets. The first nitrogen flow will determine the power input to the plasma flare as it is here that the electrical discharge occurs, while the second nitrogen flow will help control the stability of the plume and reduce fluctuations. The flows will also have an effect on dilution and thus careful control of these two flows in dependence upon the number of process chambers that are currently operational can improve efficiency, increasing breakdown of the chemicals and reducing power used.

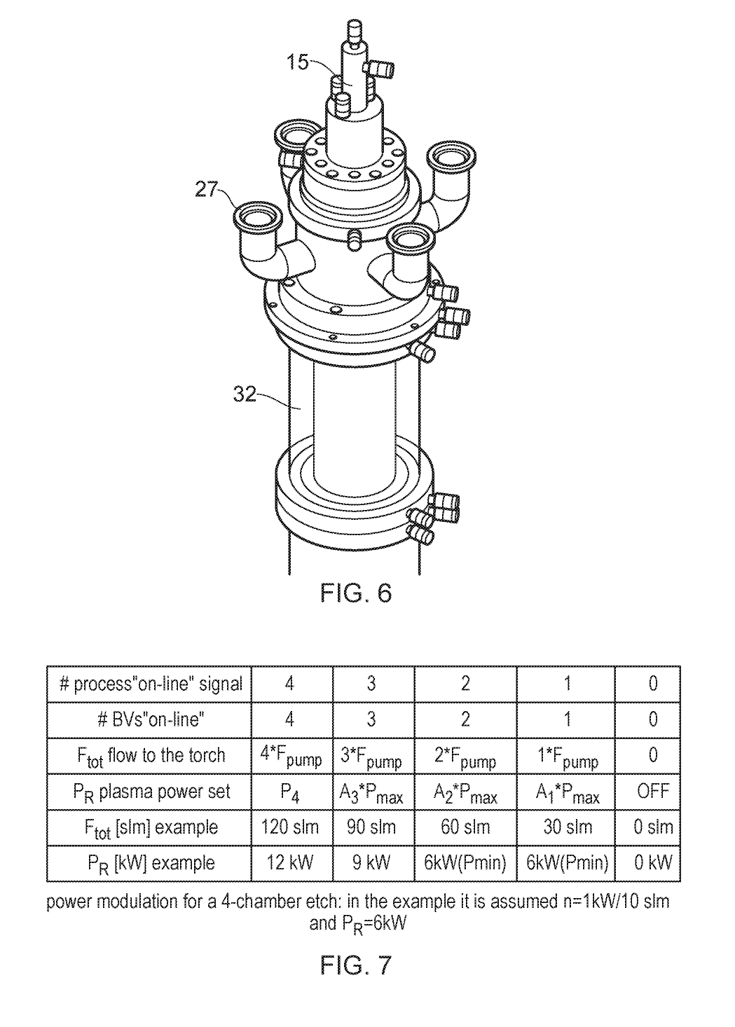

FIG. 6 schematically shows the exterior of a plasma torch according to an embodiment. The figure shows cathode 15 of the plasma torch and multiple process gas inlets 27 at equally spaced circumferential locations providing effluent gas from four different process chambers to a reaction tube 32 comprising the plasma plume. There may additionally be at least one reagent input (not shown) at a similar point on the exterior of the plasma torch. The source gas flow will be input from the top of this Figure.

FIG. 7 shows a table indicating power modulation for a four chamber etching process and illustrates how power required by the plasma torch changes with a number of process chambers that are currently online. In this embodiment, a single torch capable of delivering the required amount of power needed for the abatement of four chambers is used in combination with a reaction/inlet section and a water scrubber. Four inlets are injected in this embodiment onto the side of the plasma plume and conveyed into the hot part of the plume through an orifice or a cone. They may be conveyed subsequently to a reaction tube which can be dry or wet. The eventual residual abatement by-products are dealt with, for example, in a wet scrubber. The four inlets are controlled by bypass valves as mentioned previously and convey the effluent from each pump connected to a process chamber. A process chamber for each inlet chamber is provided along with a signal of the operational state on/off of the pump.

A power supply unit (PSU) is interfaced to programmable logic control in the form of controller 80 and can receive a demand signal on/off as well as a signal for the required amount of torch current. The PSU can also provide a readout of the torch voltage which varies approximately proportionally to the inert gas flowed through the torch anodes.

The programmable logic controller PLC can also control the bypass valves as mentioned earlier along with the torch source gas flow by means of a proportional control valve or in some embodiments a proportional flow tube as discussed later with respect to FIG. 9. The PLC for an agreed etch recipe can set a value of the power output by the PSU i.e. current from the PSU and voltage through the torch inert gas flow, corresponding to the number of chambers which are flagged as process on. The inert gas from the pumps of the chambers that are flagged as process off is sent to bypass valves without compromising safety or abatement efficiency as there are no effluent gases to be treated in this outflow.

The table of powers corresponding to the abatement of the four process chambers is shown in FIG. 7. In this embodiment, the four process chambers have similar process recipes and the same pump purge flow. The total flow to the abatement when four process chambers are online is four times the pump flow of the individual chambers and assuming a power efficiency proportionate to the dilution (typically 1 kW per 10ₛₗₘ) η,the power required in this case is P₄=η×F. Pᵣ is the power required in the case that not all the four chambers are supplying effluent. Defining the power supplied to the plasma Pᵣ=Aₓ×P₄, the power P₄ can be reduced with the scaling factor A₃, A₂ and A₁ corresponding to 3, 2 and 1 bypass valves being online when x “process on signals” are present. This is shown in the table in FIG. 7. As can be appreciated, the P required has got to be greater than Pₘᵢₙ where Pₘᵢₙ is the minimum power where the current supply to the torch is stable. In this regard, there must be a minimum power to generate a plume that is not quenched. As can be seen, as the number of chambers that are online increases, then so too does the power supplied to the torch. The power should not be reduced below the minimum power and thus in this embodiment, with either one or two process chambers online, the same amount of power is used. However, it should be appreciated that it is very rare that three process chambers are not operational at any one time and thus, the situation where one process chamber is operating on its own is very unlikely. It should be noted that in this embodiment, the process chambers all host the same process and have the same capacity and thus, the power required varies proportionally with the number of chambers that are currently operational. In some cases, different portions of the process cycle may output different gases and/or different amounts of gases. Furthermore, the process chambers may have different capacities, and may host different processes. In such a case a controller may use signals from each process chamber in conjunction with a knowledge of the process and capacity to determine the required power and vary the source gas flow as required. It should be noted that where the multiple process chambers host different processes these should be processes that output effluent gases requiring a similar temperature for treatment as clearly where processes require different temperatures then the use of a single plasma torch will no longer be effective or efficient.

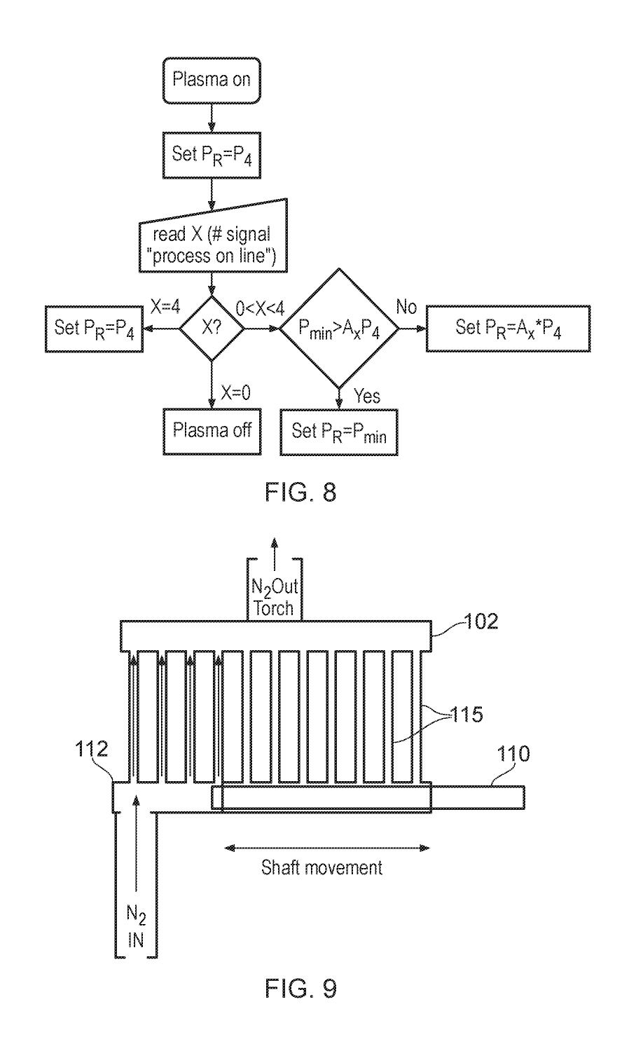

FIG. 8 shows a flow diagram illustrating the steps performed to provide automatic power control as a function of the process online signal input from the individual chambers. When the plasma torch is turned on, the power required is set to the total power of all four chambers P₄ and it is then determined how many process chambers are currently on. This is illustrated as x in the flow diagram. If x=4 then the power required is retained at P₄ while if x is less than 4, it is reduced but only as far as the minimum power required. If there are no chambers currently operational, then the plasma torch is turned off.

FIG. 9 shows a flow regulator 102 according to an embodiment. This flow regulator has the advantage of a simple yet effective design which allows changes in the plasma flow to be made in a proportional manner which is appropriate where the amount of effluent changes in a similar manner as occurs where it is dependent on the number of chambers processing similar amounts of chemicals that are either on or off. Furthermore, the amount of flow is changed by moving an obstructing member 100 with a linear motion, which allows simple control by a stepper motor. Flow regulator 102 has an input tube 110 for supplying a gas stream to an output tube 120 via an input manifold 112, parallel flow tubes 115 and an output manifold 122. In this embodiment parallel flow tubes 115 have the same diameter and thus, obstructing each one varies the flow rate in the same way. Control of the obstructing member 100 by a stepper motor (not shown), either opens or closes the parallel tubes 115 and thereby increases or decreases the flow area available to the gas flow. In this way, the flow can be varied in a simple and easily controllable manner with the closure of each tube reducing the flow by a proportional amount.

In this embodiment, flow regulator 102 is used to control the inert gas flow to the plasma torch. A similar flow regulator can be used to control reagent flow to the plasma torch. In this regard, the amount of reagent required will also vary with the number of process chambers that are currently active and will have a similar proportional requirement where the processes performed in each chamber are the same or similar. Thus, such a proportional flow regulator can be effective to control this flow too. In the case that the process chambers have different processes occurring within them or have different capacities, then it may be that a flow regulator of a similar design but with a greater number of parallel channels 115 perhaps with different diameters is required as rather than requiring say a quarter, a half or three quarters the amount of reagent or source gas, it may be that different percentages are required and thus, further tubes perhaps of different sizes may be needed to provide the different variations in the quantities provided.

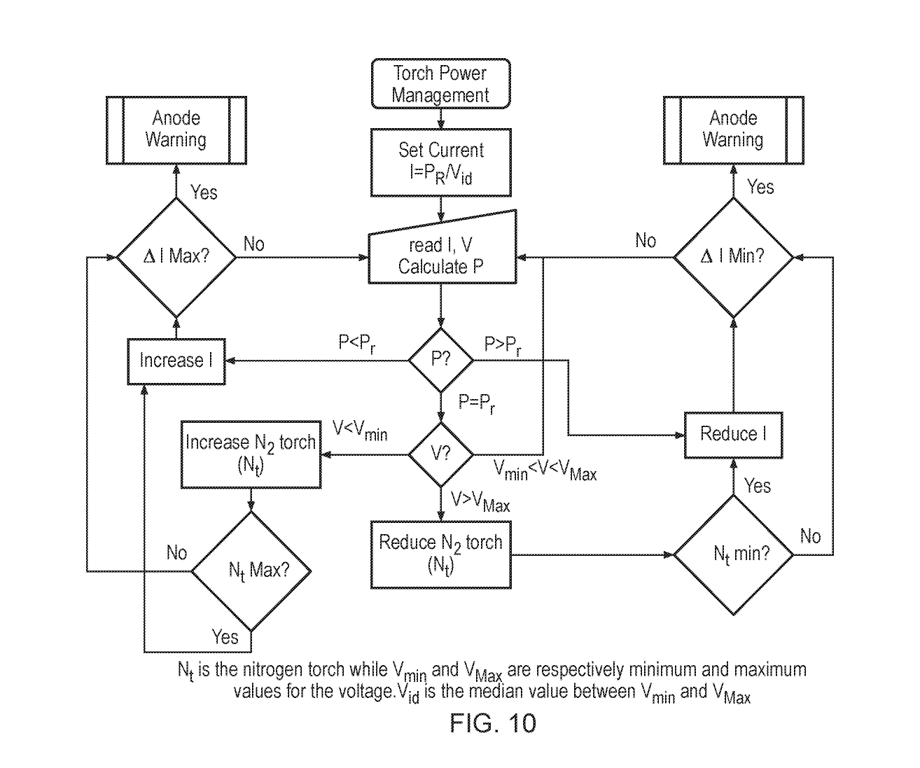

FIG. 10 shows a flow diagram illustrating steps in a method performed to control the power supplied by the power supply unit to the plasma torch to compensate for changes in power required due to anode erosion and/or powder deposition. This method can be performed to compensate for changes in the anode due to anode erosion or powder deposition in conjunction with the control of a multiple chamber system and it can be used on its own in cases where a single chamber supplies effluent to a plasma torch.

As can be seen in this flow diagram, where the torch power management system is set to on, then the current of the constant current power supply is set to a value that is dependent on the required power and on a median voltage. This median voltage is set between the minimum and maximum allowable voltages. The current and voltage being output by the power supply are continually monitored and it is determined if there are variations in the voltage required to produce this set current. If the voltage falls beneath a minimum value, then the nitrogen flow to the torch is increased to maintain the voltage above the minimum. If the voltage goes above a maximum, then the nitrogen flow to the torch is reduced to maintain the voltage at the correct value. However, there are minimum and maximum values of nitrogen flow that can be used to provide an effective plasma torch and if the minimum flow is reached, then in order to maintain the power at the required levels, the current output by the power unit is reduced avoiding the power consumed by the power supply unit rising unduly. In this way, the voltage and power levels are kept within required limits avoiding the power being output by the plasma torch gradually changing over time as anode erosion occurs. Where powder deposition at the anode occurs then the voltage will fall and this can be compensated for by an increase in the flow of the source gas. This may be advantageous as this increase in gas flow rate may help to clear the powder from the anode.

At a certain point anode erosion or powder deposition may become so great that further compensation in this way may not be possible. It is therefore convenient if this system is used in conjunction with a warning system in which warning “anode inspection” signals are generated by the control logic when it determines that the current output by a constant current power supply or the voltage output by a constant voltage power supply has increased or reduced beyond a certain level, this level being selected at a point where efficient operation of the plasma torch or the power unit may soon be compromised. Such warning signals indicate that the anode should be inspected and in some cases may soon require replacement or cleaning.

In the constant current system illustrated in FIG. 10, anode warning signals are generated when the change in current required to maintain the power within its required limits takes the current value beyond threshold minimum or maximum values.

In summary, the proposed system provides a way of tailoring the power consumption of a plasma torch abatement device according to its demand by means of controlling the source gas flow supplied to a plasma torch. This can be achieved using a tuneable power supply for a plasma torch and with the smart control of bypass valves for a multiple chamber system. According to simulations, up to 50% of power reduction can be achieved by taking into account the combined duty cycle of the individual etch chambers in a multiple process system.

In addition to controlling the power supplied to the plasma torch in dependence upon the reagent flow, an additional power control option can be added which will adjust the torch voltage and/or current which can change due to anode erosion and/or powder deposition in such a way as to keep substantially the same power consumption over time. This avoids or at least reduces changes in devices' power consumption over time and can be done in the first instance by adjusting the torch plasma source gas flow. When this reaches its interlock value, torch power can be changed by varying the constant voltage or current supplied. Laboratory tests have shown that within 20% of torch current variation, the same DRE (destruction or removal efficiency) is returned by the same power.

In addition to the above, the control of the reagent flow such as CDA, oxygen and water vapour, as a function of the number of process on line signals can be performed in order to match the exact stoichiometry required. This can reduce NOₓ emissions, reduce the cost of operation and has a beneficial impact on DRE and the lifetime of the components.

Furthermore, a flow regulator comprising a proportional flow tube instead of a proportional control valve such as is shown in FIG. 9 can be used to control the flowrate of the source gas or the reagent gas. This device can provide a cheap and simple flow system for use in the power and reagent control.

This DC-arc torch system is particularly effective in the Semi-Etch market which is currently dominated by a fixed single power DC-arc torch system. The semi-etch market requires high powers to break down stable greenhouse gases such as CF₄ and SF₆. The stability of these compounds mean the power requirements for their abatement are very high and thus, a system that can vary power depending on requirements can be highly advantageous. In summary, a tuneable power torch with an abatement system that is particularly applicable for both semi-conductor etch and FPD etch systems and provide proportional flow tube gas control and bypass valve control dependent on process signals is provided.

Although embodiments show a DC power supply supplying a substantially constant controllable current, it will be appreciated that an AC power supply could be used. Furthermore the AC power supply could be a constant voltage power supply and in this case changes in source gas flow rate would change the current generated by such a power supply and therefore change the power output by the power supply.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A method of controlling power output by a power supply configured to supply power to a plasma torch in a gas treatment system, said plasma torch being configured to treat effluent gas received from at least two processing chambers, said method comprising:
receiving at least one input signal, said at least one input signal comprising an indication of a number of processing chambers currently supplying an effluent gas stream to said plasma torch; and
in response to said at least one input signal, controlling said power output by said power supply by outputting a control signal to control a rate of flow of a plasma source gas supplied to said plasma torch.

2. The method according to claim 1, wherein said at least one input signal comprising said indication of said number of processing chambers comprises a signal received from each of said processing chambers.

3. The method according to claim 2, wherein said signal comprises at least one of: an indication of a current process in said corresponding processing chamber; an indication of an operation of a pump supplying effluent from said corresponding process chamber to said plasma torch; and a state of a bypass valve, said bypass valve being configured to supply said effluent from said corresponding processing chamber to said plasma torch in a first state and not to supply said effluent to said plasma torch in a second state.

4. The method according to claim 1, wherein each of said processing chambers comprises a bypass valve, said bypass valve being configured to supply said effluent from said corresponding processing chamber to said plasma torch in a first state and not to supply said effluent to said plasma torch in a second state, said method comprises a further step of outputting at least one control signal to control at least one of said bypass valves.

5. The method according to claim 4, wherein said at least one input signal comprises an indication of an operation of a pump supplying effluent from said corresponding process chamber to said plasma torch, said method comprising in response to determining at least one of said pumps switching between operational and non-operational states, controlling said corresponding at least one bypass valve to switch between said first and said second states such that when said pump is not operational said corresponding bypass valve does not supply effluent to said plasma torch.

6. The method according to claim 4 wherein said at least one input signal comprises an indication of a current process in said corresponding processing chamber, said method comprising in response to determining at least one of said processing chambers switching between an idle and an operational state, outputting at least one control signal to control a corresponding at least one of said bypass valves to switch between said first and said second state such that when said processing chamber is idle said corresponding bypass valve does not supply effluent to said plasma torch.

7. The method according to claim 1, further comprising a step of outputting a further control signal for controlling a rate of flow of reagent for treating said effluent gas stream in dependence upon said number of processing chambers currently supplying effluent to said plasma torch.

8. The method according to claim 1, wherein said plasma torch comprises at least two anodes, said plasma source gas being supplied to said plasma torch in at least two plasma source gas streams at at least two points in said plasma torch, said step of controlling said rate of flow of said plasma source gas stream comprises independently controlling a rate of flow of each of said at least two plasma source gas streams.

9. The method according to claim 1, comprising receiving at least one further input signal comprising at least one of a current output to said plasma torch, a voltage output to said plasma torch and a flow rate of a plasma source gas supplied to said plasma torch.

10. The method according to claim 1, wherein said power supply unit comprises a DC power supply configured to supply a substantially constant current to said plasma torch.

11. The method according to claim 1, wherein said at least one input signal further comprises a signal indicative of said power output by said power supply, said method comprising a further step of monitoring changes in said power output and where said changes take a power output by said power supply outside of predetermined limits, outputting a control signal to adjust said power output by said power supply to within said predetermined limits.

12. The method according to claim 11, wherein said method comprises prior to outputting said control signal, determining whether adjusting said power by adjusting a flow rate of said plasma source gas would bring said flow rate outside of predetermined flow rate limits and if not:
outputting said control signal to adjust said rate of flow of said plasma source gas; and if so
outputting a control signal to adjust a level of one of said current and said voltage output by said power supply to bring said power output within said predetermined power limits.

13. The method according to claim 11, comprising a further step of outputting an anode inspection signal in response to determining that said current or voltage output by said power supply has passed at least one predetermined value.

14. A computer program which when executed by a processor is operable to control said processor to performs steps in a method according to claim 1.

15. A controller for controlling a power output by a power supply configured to supply power to a plasma torch in an abatement system, said controller comprising:
an input configured to receive at least one input signal, said at least one input signal comprising an indication of a number of processing chambers currently supplying effluent to said plasma torch;
logic configured to generate at least one control signal in dependence upon said at least one input signal, said at least one control signal controlling said power output by said power supply by controlling a rate of flow of a plasma source gas supplied to said plasma torch; and
an output for outputting said generated control signal.

16. The controller according to claim 15, wherein said power supply comprises a substantially constant DC current power supply.

17. The controller according to claim 15, wherein said logic comprises programmable control logic comprising a computer program.

18. An apparatus for treating gas streams from multiple processing chambers comprising:
a plasma torch for generating a plasma plume from a source gas when energised by electrical energy;
a power supply for supplying said electrical energy to said plasma torch;
a flow rate regulator for regulating a rate of flow of said plasma source gas to said plasma torch; and
a controller comprising:
an input configured to receive at least one input signal, said at least one input signal comprising an indication of a number of processing chambers currently supplying effluent to said plasma torch;
logic configured to generate at least one control signal in dependence upon said at least one input signal; and
an output for outputting said generated control signal to the flow rate regulator to control the rate of flow of said plasma source gas supplied to said plasma torch.

19. The apparatus according to claim 18, wherein said flow rate regulator comprises:
an input channel and an output channel, said input channel being in fluid communication with an input manifold and said output channel being in fluid communication with an output manifold;
a plurality of flow channels running from said input manifold to said output manifold;
a movable obstructing member operable to move within one of said input or output manifold to obstruct one or more of said plurality of flow channels in response to a control signal received from said controller, movement of said obstructing member being operable to vary a number of channels available for flow of said plasma source gas from said input channel to said output channel, and thereby vary said flow rate of said source gas supplied to said plasma torch.

20. The apparatus according to claim 19, wherein said plurality of channels of said flow rate regulator are parallel channels and opening or closing each of said channels changes a flow rate by an amount dependent on a cross sectional area of said channel.

21. The apparatus according to claim 19, wherein said flow rate regulator comprises a stepper motor configured to control said movement of said obstructing member and thereby said number of channels obstructed.

22. The apparatus according to claim 18, wherein said plasma torch comprises a plurality of inputs for receiving effluent gas streams from a corresponding plurality of processing chambers.

23. The apparatus according to claim 22, wherein said plasma torch comprises four inputs for receiving effluent gas streams from four processing chambers.

24. The apparatus according to claim 18, further comprising a reagent input channel for inputting a reagent to said plasma torch and a flow rate regulator for regulating an amount of said reagent input to said plasma torch in dependence upon said number of processing chambers currently supplying effluent to said plasma torch.

25. The apparatus according to claim 24, wherein said reagent flow rate regulator comprises an input channel and an output channel, said input channel being in fluid communication with an input manifold and said output channel being in fluid communication with an output manifold, a plurality of flow channels running from said input manifold to said output manifold, a movable obstructing member operable to move within one of said input or output manifold to obstruct one or more of said plurality of flow channels in response to a control signal received from said controller, movement of said obstructing member being operable to vary a number of channels available for flow of said reagent from said input channel to said output channel, and thereby vary said flow rate of said reagent supplied to said plasma torch.

26. The apparatus according to claim 18, wherein said plasma torch comprises a cylindrical anode, and a cathode located at least partially within said cylindrical anode, said power supply supplying an electrical signal to said cylindrical anode.

27. The apparatus according to claim 26, wherein said plasma torch comprises a plurality of anodes with a plurality of plasma source gas inputs, plasma source gas supplied to each plasma source gas input being controlled by a flow rate regulator.

28. The apparatus according to claim 18, wherein said power supply is a substantially constant current DC power supply.

29. A flow rate regulator for regulating a flow of a fluid comprising:
an input channel and an output channel, said input channel being in fluid communication with an input manifold and said output channel being in fluid communication with an output manifold;
a plurality of flow channels running from said input manifold to said output manifold; a movable obstructing member operable to move to obstruct one or more of said plurality of flow channels in response to a control signal, movement of said obstructing member being operable to vary a number of channels available for flow of said fluid from said input channel to said output channel, and thereby vary said flow rate of said fluid supplied from said flow rate regulator.

30. The flow rate regulator according to claim 29, wherein said plurality of channels of said flow rate regulator are substantially parallel channels.

31. The flow rate regulator according to claim 30, wherein said plurality of channels have substantially a same cross sectional area.

32. The flow rate regulator according to claim 29, wherein said obstructing member is operable to move in a linear manner in one of said input or output manifold.

33. The flow rate regulator according to claim 29, further comprising a stepper motor operable to control said movement of said obstructing member and thereby said number of channels obstructed.

34-38. (canceled)
